(19) United States
(12) Patent Application Publication
(10) Pub. No.: US 2026/0270281 A1
(43) Pub. Date: Sep. 10, 2026

(54) METHOD FOR IDENTIFYING COVERT MALICIOUS TRAFFIC BASED ON FLIPPED GRAPH AND DEVICE

(71) Applicants: TSINGHUA UNIVERSITY, BEIJING (CN); CHINA TELECOM CYBERSECURITY TECHNOLOGY CO., LTD., SUZHOU (CN)

(72) Inventors: KE XU, BEIJING (CN); FAN LI, BEIJING (CN); YI ZHAO, BEIJING (CN); QI LI, BEIJING (CN); LIYUAN CHANG, SUZHOU (CN)

(21) Appl. No.: 19/557,042

(22) Filed: Mar. 4, 2026

(30) Foreign Application Priority Data
Mar. 5, 2025 (CN) 2025102535803

(51) Int. Cl. H04L 9/40; H04L 41/16

(52) U.S. Cl. CPC H04L 63/1425; H04L 41/16

(57) ABSTRACT

A method for identifying covert malicious traffic based on a flipped graph and a device are provided. The method includes: constructing a flipped graph of traffic interaction, and determining edge connections between the nodes through relationships between source addresses and destination addresses of the flows; performing a graph learning using a graph convolutional neural network, aggregating, for each node in the flipped graph, its own node feature and features of neighboring nodes, and training a neural network model in combination with node labels to identify a degree of maliciousness of each node; constructing a node feature of a flow to be detected, finding its neighboring nodes in an existing flipped graph and calculating a node embedding of the flow; inputting the node embedding of the flow to be detected into a trained graph convolutional neural network model to perform a malicious traffic identification.

### CROSS-REFERENCE TO RELATED PATENT APPLICATION

The present disclosure claims priority to Chinese Patent Application No. 2025102535803, filed on Mar. 5, 2025, the entire content of which is incorporated herein by reference for all purposes.

### FIELD OF THE DISCLOSURE

The present disclosure relates to the technical fields of next-generation Internet application security, network space security, and covert malicious traffic identification, and in particular to a method and device for identifying covert malicious traffic based on a flipped graph.

### BACKGROUND OF THE DISCLOSURE

Many scenarios can be well represented by graph structures, such as friend relationships in social networks, relationships between biological entities (e.g., genes, proteins, etc.), and traffic interaction relationships in networks. In a graph structure, both nodes and edges can have features. Two nodes connected by an edge are neighboring nodes of each other. In real-world scenarios, features of neighboring nodes often have certain similarities or correlations.

A Graph Convolutional Neural Network (GCN) is a mainstream graph learning method. This method analogizes the definition of convolution in the field of image recognition, defining the convolution operation on a graph as the aggregation of features of neighboring nodes. GCN emphasizes learning node features, where edges often only provide connectivity information with weights, and existing methods do not fully utilize the information on edges. However, there are some scenarios in reality where the natural graph structure makes it difficult to obtain node features, but edge features contain rich information, and the task in such scenarios is edge-oriented. For example, in the task of covert malicious traffic identification, the network traffic interaction relationship naturally has a graph structure with addresses as nodes and traffic as edges. Edges can use traffic statistical information as features, while node features are difficult to define. For such scenarios, GCNs struggle to fully utilize the information on edges, leading to poor learning outcomes.

### SUMMARY OF THE DISCLOSURE

The present disclosure aims to solve at least one of the technical problems in the related art to a certain extent.

To this end, a first objective of the present disclosure is to provide a method for identifying covert malicious traffic based on a flipped graph.

A second objective of the present disclosure is to provide a device for identifying covert malicious traffic based on a flipped graph.

A third objective of the present disclosure is to provide an electronic device.

A fourth objective of the present disclosure is to provide a computer-readable storage medium.

A fifth objective of the present disclosure is to provide a computer program product.

To achieve the above objectives, a first aspect embodiment of the present disclosure provides a method for identifying covert malicious traffic based on a flipped graph, including:
constructing a flipped graph of traffic interaction, taking flows as nodes in the graph, taking statistical features of the flows as node features, and determining edge connections between the nodes through relationships between source addresses and destination addresses of the flows;
performing a graph learning using a graph convolutional neural network, aggregating, for each node in the flipped graph, its own node feature and features of neighboring nodes, and training a neural network model in combination with node labels to identify a degree of maliciousness of each node;
constructing a node feature of a flow to be detected, finding its neighboring nodes in an existing flipped graph and calculating a node embedding of the flow;
inputting the node embedding of the flow to be detected into a trained graph convolutional neural network model to perform a malicious traffic identification.

Optionally, the constructing the flipped graph of traffic interaction includes:
processing a series of data packets with known labels arranged in time order into flows, calculating statistical features of each flow, and using dictionary flows to record flow information, where a key of the dictionary flows is flow identification information, and values of the dictionary flows are flow statistical features including a packet length distribution and a packet interval distribution;
converting the dictionary flows into an array flows_arr, combining keys and values of the dictionary as content of array elements; using a dictionary graph to record association relationships between an address and a flow index, where keys of the dictionary graph are source addresses and destination addresses, and a value of the dictionary graph is a corresponding flow index;
obtaining a source address and a destination address of each element in the array flows_arr, and adding an index of the element respectively to dictionary entries keyed by the source address and the destination address, to construct a topological structure of the flipped graph of the traffic interaction.

Optionally, the performing graph learning using a graph convolutional neural network, aggregating, for each node in the flipped graph, its own node feature and features of neighboring nodes, and training a neural network model in combination with node labels to identify a degree of maliciousness of each node, includes:
initializing the graph convolutional neural network model, wherein the graph convolutional neural network model comprises an embedding generator [symbol] and a discriminator [symbol] , the embedding generator [symbol] is used to calculate a current node embedding based on a feature of a current node and features of neighboring nodes, and the discriminator [symbol] is used to evaluate the degree of maliciousness of the current node based on the current node embedding and the feature of the current node;
training the graph convolutional neural network model, wherein v⁽ⁱ⁾ is defined as a feature of a node i and w⁽ⁱ⁾ is defined as an embedding of the node

$${𝒩}_{s}^{( i )}$$

is a set of neighboring nodes sharing a common source address with the node i,

$${𝒩}_{d}^{( i )}$$

is a set of neighboring nodes sharing a common destination address with the node i,
randomly sampling a fixed number of nodes from the set of neighboring nodes for an aggregation, adjusting aggregation weights based on similarities between the features of the neighboring nodes and the feature of the current node, respectively calculating embeddings of the neighboring nodes associated by the source address and by the destination address, and combining the embeddings of the neighboring nodes to serve as the embedding w⁽ⁱ⁾ of the current node i, wherein a merging formula is:

$${w}^{( i )} = ( \frac{{\sum }_{j ∈ Sample ( {𝒩}_{s}^{( i )} , k )} {r}_{j}^{( i )} \cdot {v}^{( j )} )}{{\sum }_{j ∈ Sample ( {𝒩}_{s}^{( i )} , k )} {r}_{j}^{( i )}} \vert \vert \frac{{\sum }_{j ∈ Sample ( {𝒩}_{d}^{( i )} , k )} {r}_{j}^{( i )} \cdot {v}^{( j )}}{{\sum }_{j ∈ Sample ( {𝒩}_{d}^{( i )} , k )} {r}_{j}^{( i )}} )$$

wherein

$${r}_{j}^{( i )} \qquad ( i )$$

is a weight of neighboring node j, v^{(j)} is a feature of neighboring node j, Sample(S,k) represents randomly sampling k elements from set S, and ∥ represents concatenating two vectors end-to-end into one vector; combining v⁽ⁱ⁾ and w⁽ⁱ⁾ and inputting the combined v⁽ⁱ⁾ and w⁽ⁱ⁾ into the discriminator [symbol] to obtain a score of maliciousness degree of node, and performing a backpropagation of a difference between the score of maliciousness degree of node output by the discriminator [symbol] and the node label to update parameters of the discriminator [symbol] ; and
performing a training process for each node in the flipped graph, and repeating the training process for multiple rounds until the discriminator [symbol] converges, outputting a maliciousness score of each node, and simultaneously recording a threshold for the trained data to achieve an optimal balance between recall rate and false positive rate, wherein a calculation method is:

$$threshold = arg max ( TPR \cdot ( 1 - F P R ) )$$

wherein TPR and FPR are respectively the recall rate and false positive rate of the model under different thresholds.

Optionally, the embedding generator [symbol] adopts a non-parametric algorithm and requires no initialization; and
the discriminator [symbol] adopts a neural network model, wherein in a case where a node feature dimension is d, an input dimension of the discriminator [symbol] is 3·d, and an output dimension of the discriminator [symbol] is 1; a neural network parameter of the discriminator [symbol] is initialized by a random initialization method as follows: for a parameter matrix A⁽ⁱ⁾ of layer l, wherein l>1, the elements of the parameter matrix A^{(l)} follow a Gaussian distribution with a mean 0 and a variance \sqrt{2/nₗ₋₁}, where nₗ₋₁ is a number of neurons in a layer l−1, and parameters of a first layer are initialized as a random real matrix following a standard normal distribution.

Optionally, constructing the node feature of the flow to be detected, finding the neighboring node in the flipped graph and calculating the node embedding of the flow to be detected, comprises:
obtaining a five-tuple array and flow statistical information of the flow to be detected, and adding the five-tuple array and the flow statistical information to the flow information array flows_arr;
based on a source address and a destination address of the flow to be detected, finding a source address neighbor set and a destination address neighbor set of the flow to be detected in an address-associated flow dictionary graph, and adding an index of the flow respectively to source address and destination address entries in the address-associated flow dictionary graph; and
merging an embedding of the source address neighbor node and an embedding of the destination address neighbor node to obtain the node embedding of the flow to be detected.

Optionally, inputting the node embedding of the flow to be detected into the trained graph convolutional neural network model to perform the malicious traffic identification comprises:
inputting the calculated node embedding of the flow to be detected into the trained graph convolutional neural network model to obtain a maliciousness score of the flow; and
comparing the maliciousness score of the flow to be detected with the threshold to determine whether the flow to be detected is a malicious flow.

Optionally, comparing the maliciousness score of the flow to be detected with the threshold to determine whether the flow to be detected is a malicious flow comprises:
in a case where the maliciousness score is greater than or equal to the threshold, determining that the flow is a malicious flow, and generating an alert message; and
in a case where the maliciousness score is less than the threshold, determining that the flow is a normal flow, and not triggering an alert.

To achieve the above objectives, a second aspect embodiment of the present disclosure provides a device for identifying covert malicious traffic based on a flipped graph, including:
a flipped graph construction module, configured to construct a flipped graph of a traffic interaction by taking flows as nodes in the flipped graph and taking statistical features of the flows as node features, and determine edge connections between the nodes based on relationships between source addresses and destination addresses of the flows;
a training module, configured to perform a graph learning using a graph convolutional neural network, aggregate, for each node in the flipped graph, a node feature of each node and a feature of a neighboring node, and train a neural network model using a node label to identify a degree of maliciousness of each node; and
a malicious traffic identification module, configured to input the node embedding of the flow to be detected into a trained graph convolutional neural network model to perform a malicious traffic identification.

To achieve the above objectives, a third aspect embodiment of the present disclosure provides an electronic device, including: a processor, and a memory communicatively connected to the processor;
the memory stores computer-executable instructions;
the processor executes the computer-executable instructions stored in the memory to implement the method according to any one of the first aspect.

To achieve the above objectives, a fourth aspect embodiment of the present disclosure provides a computer-readable storage medium, where the computer-readable storage medium stores computer-executable instructions, which when executed by a processor are used to implement the method according to any one of the first aspect.

To achieve the above objectives, a fifth aspect embodiment of the present disclosure provides a computer program product, which when executed by a processor implements the method according to any one of the first aspect.

The technical solutions provided by the embodiments of the present disclosure bring at least the following beneficial effects:

It solves the problem that graph learning algorithms have poor learning effects in traffic identification scenarios due to difficulty in fully utilizing flow feature information on edges, thereby improving the identification effect of covert malicious traffic; the flipped graph, by taking flows as nodes and determining node connections based on whether flows share a common source and destination, presents flow statistical features in the form of node features, enabling graph learning algorithms to better utilize effective information of traffic data; by adopting a graph convolutional neural network, it can utilize the aggregation characteristic of attack traffic, and weightedly aggregate features of the current node and its neighboring nodes, making malicious nodes and normal nodes more separated in the vector space, improving the accuracy and robustness of identification.

Additional aspects and advantages of the present disclosure will be set forth in part in the following description, and in part will become apparent from the following description, or may be learned through practice of the present disclosure.

### BRIEF DESCRIPTION OF THE DRAWINGS

The above and/or additional aspects and advantages of the present disclosure will become apparent and easily understood from the description of the embodiments in conjunction with the following drawings, where:

FIG. 1 is a schematic flow diagram of a method for identifying a covert malicious traffic based on a flipped graph in an embodiment of the present disclosure;

FIG. 2 is a schematic structural diagram of a device for identifying a covert malicious traffic based on a flipped graph in an embodiment of the present disclosure.

### DETAILED DESCRIPTION OF THE EXEMPLARY EMBODIMENTS

Embodiments of the present disclosure are described in detail below, examples of which are illustrated in the accompanying drawings, where the same or similar reference numerals throughout indicate the same or similar elements or elements having the same or similar functions. The embodiments described below with reference to the drawings are exemplary, intended to explain the present disclosure, and should not be construed as limiting the present disclosure.

To solve the problem of insufficient utilization of flow features in graph-based malicious traffic identification, an embodiment of the present disclosure provides a method for identifying covert malicious traffic based on a flipped graph, using a flipped graph to depict information associations in the scene, taking edges in the natural graph structure as nodes in the flipped graph, and taking the relationship of whether edges share a common start or end point as edges in the flipped graph. Thus, nodes in the flipped graph have rich features, while edges provide connectivity information, enabling effective learning on the flipped graph using graph convolutional neural network methods.

And further, applying the above method to model traffic interaction patterns in a network, representing traffic as a flipped graph with flows as nodes and topological associations between flows as edges, using statistical features of flows as node features, employing a graph convolutional neural network for graph learning and performing malicious traffic identification, thereby improving the malicious traffic identification effect.

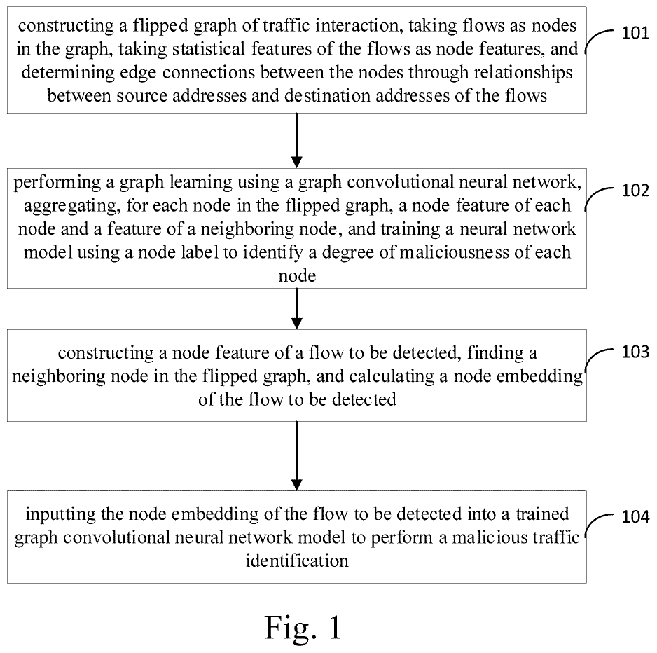

FIG. 1 is a schematic flow diagram of a method for identifying covert malicious traffic based on a flipped graph in an embodiment of the present disclosure. As shown in FIG. 1, the method includes the following steps:
Step 101: constructing a flipped graph of traffic interaction, taking flows as nodes in the graph, taking statistical features of the flows as node features, and determining edge connections between the nodes through relationships between source addresses and destination addresses of the flows.

In an embodiment of the present disclosure, the purpose of step 101 is to construct a flipped graph of traffic interaction, where flows are taken as nodes in the graph, statistical features of the flows are taken as node features, and edge connections between nodes are determined through the relationship between source addresses and destination addresses of the flows.

Specifically, the construction process is as follows:

First, a series of data packets with known labels arranged in time order are processed into flows, and statistical features of each flow are calculated. The process of processing data packets merges multiple data packets into one flow. Flow identification information can be defined in various ways, for example, based on information such as source address, destination address, source port, destination port, and protocol number, or other identification methods suitable for specific application scenarios, which are not specifically limited in the present disclosure. The statistical features of a flow are used to describe the behavior pattern of the flow, and specific features may include but are not limited to packet length distribution, packet interval distribution, etc., and are not limited to specific statistics. After the data packets are processed into flows, the identification information of each flow and the corresponding statistical features are recorded through a dictionary flows. The key of this dictionary is used to uniquely identify the flow, and the value of the dictionary stores the statistical features of the flow. The specific types of statistical features can be selected according to actual application requirements, not limited to packet length distribution and packet interval distribution, but can cover various statistical information applicable in traffic pattern analysis.

Then, the dictionary flows are converted into an array flows_arr. In this process, the key and value information of the dictionary flows are merged to form an array, where each element contains the flow identification information and the statistical features of the flow, and each element in the array represents a node in the graph, with the flow identification information as the node identifier and the statistical features of the flow as the features of the node.

Furthermore, in the embodiment of the present disclosure, a dictionary graph is also used to record the association relationship between addresses and flow indices. The keys of the dictionary graph are source addresses and destination addresses, and the values of the dictionary are the corresponding flow indices. When processing each element in the flows_arr array, it is necessary to obtain the source address and destination address of each element, and add the index of the element to the source address and destination address entries in the dictionary graph respectively.

Through the above steps, a topological structure of a flipped graph of traffic interaction can be constructed, where flows form connecting edges in the graph through the relationship between source addresses and destination addresses, and the statistical features of flows serve as features of each node. This flipped graph provides basic data for subsequent graph convolutional neural network learning.
Step 102: performing a graph learning using a graph convolutional neural network, aggregating, for each node in the flipped graph, a node feature of each node and a feature of a neighboring node, and training a neural network model using a node label to identify a degree of maliciousness of each node.

In an embodiment of the present disclosure, the purpose of step 102 is to perform graph learning on the flipped graph through a graph convolutional neural network (GCN) to identify the degree of maliciousness of each node in the flipped graph. GCNs are particularly suitable for processing graph-structured data, capable of learning latent features of nodes by aggregating information from neighboring nodes, thereby effectively performing traffic maliciousness detection.

Specifically, step 102 includes the following sub-steps:
Step 201: initializing the graph convolutional neural network model.

The graph convolutional neural network model in the embodiment of the present disclosure includes two main parts: an embedding generator [symbol] and a discriminator [symbol] . The function of the embedding generator [symbol] is to calculate the embedding of the current node based on the features of the current node and its neighboring nodes. This generator adopts a non-parametric algorithm, so initialization of the embedding generator is not required at the beginning of training, thereby reducing the complexity and computational resources required for model initialization. The function of the discriminator [symbol] is to evaluate the maliciousness degree of the node based on the embedding of the current node and the node feature. It adopts a standard neural network model. If the node feature dimension is d, the input dimension of the discriminator is 3·d, i.e., three times the node feature, and the output dimension is 1, representing the maliciousness score of the node.

During the initialization of the discriminator, parameters are set by a random initialization method. In the specific initialization process, for the parameter matrix A^{(l)} of layer l (l>1), its elements follow a Gaussian distribution with a mean of 0 and a variance of \sqrt{2/nₗ₋₁}, where nₗ₋₁ is the number of neurons in layer l−1; parameters of the first layer are initialized as a random real matrix following a standard normal distribution. This random initialization method effectively avoids the gradient vanishing problem, thereby improving the stability of the network training process.
Step 202: training the graph convolutional neural network model.

First, v⁽ⁱ⁾ is defined as the feature of node $i$, and w⁽ⁱ⁾ is defined as the embedding of node i. The feature of each node i will be updated based on information from its neighboring nodes. Therefore, an important step is to determine which nodes are related to the current node. For each node i,

$${𝒩}_{s}^{( i )}$$

is defined as the set of neighboring nodes sharing a common source address with node i, and

$${𝒩}_{d}^{( i )}$$

is defined as the set of neighboring nodes sharing a common destination address with node i. The features of neighboring nodes will affect the final feature of the current node, thereby affecting its maliciousness score.

To fix the number of neighboring nodes for parallel computation, while enhancing the robustness of the model and improving computational efficiency, the embodiment of the present disclosure does not use all neighboring nodes for training, but randomly samples a fixed number of elements from each neighboring node set for feature aggregation. The rationale for this approach is that malicious traffic usually exhibits aggregation, meaning that features of malicious traffic have strong correlations among traffic sharing the same source or destination address. Therefore, aggregating by randomly sampling some nodes from the neighboring node set helps reduce the impact of noise and improves the stability of the model. Considering that the purpose of aggregating neighboring node features is to enhance node features using the aggregation characteristic of malicious traffic, when aggregating node features, neighboring nodes more similar to the feature of the current node should be assigned higher weights.

Furthermore, unlike a graph with addresses as nodes, due to the unidirectional nature of flow definition, neighboring nodes associated by source address and destination address in a flipped graph with flows as nodes may have different aggregation characteristics. Therefore, the embodiment of the present disclosure separately calculates the embeddings of neighboring nodes associated by source address and by destination address, and then combines these two embeddings to serve as the final embedding of the current node.

In an embodiment, an end-to-end concatenating is used for embedding fusion, with the formula:

$${w}^{( i )} = ( \frac{{\sum }_{j ∈ Sample ( {𝒩}_{s}^{( i )} , k )} {r}_{j}^{( i )} \cdot {v}^{( j )} )}{{\sum }_{j ∈ Sample ( {𝒩}_{s}^{( i )} , k )} {r}_{j}^{( i )}} \vert \vert \frac{{\sum }_{j ∈ Sample ( {𝒩}_{d}^{( i )} , k )} {r}_{j}^{( i )} \cdot {v}^{( j )}}{{\sum }_{j ∈ Sample ( {𝒩}_{d}^{( i )} , k )} {r}_{j}^{( i )}} )$$

where

$${r}_{j}^{( i )}$$

is a weight of neighboring node j, v^{(j)} is a feature of neighboring node j, Sample(S,k) represents randomly sampling k elements from set S, and ∥ represents concatenating two vectors end-to-end into one vector.

After calculating the embedding vector w⁽ⁱ⁾, v⁽ⁱ⁾ and w⁽ⁱ⁾ are combined and input into the discriminator [symbol] to obtain a node maliciousness degree score. This score represents the likelihood that the node is malicious traffic, with a higher value indicating a higher probability that the node is malicious traffic.

Furthermore, to train the discriminator [symbol] , the embodiment of the present disclosure performs backpropagation on the difference between the node maliciousness degree score output by the discriminator [symbol] and the node label to update the discriminator parameters.
Step 203: performing the above training process (step 202) for each node in the flipped graph, and repeating for multiple rounds until the discriminator [symbol] converges, finally outputting the maliciousness score for each node.

In addition, the present disclosure also designs a threshold determination mechanism to balance the detection precision and recall rate of malicious traffic. By calculating the recall rate and false positive rate of the model under different thresholds, the optimal threshold is selected to achieve the best balance between recall rate and false positive rate. The calculation method for this optimal threshold is as follows:

$$threshold = arg max ( TPR \cdot ( 1 - F P R ) )$$

where TPR and FPR are respectively the recall rate and false positive rate of the model under different thresholds.

Through the above steps, the present disclosure can fully utilize the advantages of graph convolutional neural networks to achieve efficient feature learning and accurate malicious traffic detection in malicious traffic identification. This method can effectively capture relationships between nodes and accurately identify malicious traffic by aggregating feature information from neighboring nodes, greatly enhancing network security protection capabilities.
Step 103: constructing a node feature of a flow to be detected, finding a neighboring node in the flipped graph, and calculating a node embedding of the flow to be detected.

In an embodiment of the present disclosure, the purpose of step 103 is to construct node features for the flow to be detected and calculate the node embedding of the flow by finding neighboring nodes in the existing flipped graph. The core goal of this process is to effectively combine the features of the flow to be detected with the information in the flipped graph, thereby providing accurate input features for malicious traffic identification. Specifically, step 103 includes the following key sub-steps:

First, flow identification information and flow statistical features of the flow to be detected are obtained. The flow identification information of the flow to be detected can be defined based on various methods, for example, using a combination of source address, destination address, source port, destination port, and protocol number, or other identification methods suitable for actual application scenarios, which are not specifically limited in the present disclosure. This information can uniquely identify the presence of the flow in the network. In addition to the identification information, statistical features of the flow to be detected (such as packet length distribution, packet interval distribution, etc.) are also calculated and extracted. These features help describe the behavior pattern of the flow and provide important basis for subsequent malicious traffic identification. All the information will be added to the flow information array flows_arr as the basic description of the flow.

The flows_arr array is a data structure that stores information of all flows, where the information of each flow includes its identification information and related statistical features, as explained previously.

Next, based on the source address and destination address of the flow to be detected, its neighboring nodes are found in the address-associated flow dictionary graph. The dictionary graph is used to store the association relationship between source/destination addresses and flow indices. Specifically, for the source address and destination address of the flow to be detected, the embodiment of the present disclosure queries the graph dictionary respectively to find the sets of neighboring nodes related to it. These neighboring nodes represent other flows that have a relationship with the flow to be detected in the network, and their features will influence the maliciousness assessment of the flow to be detected.

After obtaining the neighbor sets for the source address and destination address of the flow to be detected, the embodiment of the present disclosure further calculates the embedding information of these neighboring nodes. In the existing flipped graph, the embedding of each node is derived by aggregating features of its neighboring nodes. Therefore, the node embedding for the flow to be detected needs to be obtained by fusing the embedding of the source address neighbor node and the embedding of the destination address neighbor node. The fused embedding will serve as the final node embedding for the flow to be detected, to be used by the subsequent discriminator model for maliciousness assessment.

It should be noted that the specific embedding calculation process has been detailed in step 202 and will not be repeated or described again in this step.
Step 104: inputting the node embedding of the flow to be detected into a trained graph convolutional neural network model to perform a malicious traffic identification.

In an embodiment of the present disclosure, the purpose of step 104 is to input the calculated node embedding of the flow to be detected into the trained graph convolutional neural network model to determine whether the flow is malicious traffic. This process is the core of malicious traffic detection, aiming to perform traffic classification judgment through the prediction results of the model.

Specifically, first, the node embedding of the flow to be detected calculated in the previous step is input into the trained graph convolutional neural network model. By passing this embedding to the already trained graph convolutional neural network, the network can utilize the learned model parameters to classify the flow to be detected and output its maliciousness score.

Next, through the output of the model, the maliciousness score of the flow to be detected is obtained. This score reflects the likelihood that the flow to be detected is judged as malicious. The neural network model combines the input node embedding with the learned parameters to generate a numerical value representing the degree of maliciousness. The higher the maliciousness score, the stronger the maliciousness of the flow is, and conversely, the lower the score, the greater the possibility that the flow is normal traffic.

In one embodiment of the present disclosure, if the maliciousness score output by the model is greater than or equal to the threshold $threshold$, the flow is determined to be a malicious flow, and alert information is generated to notify the network administrator that the traffic may contain malicious behavior, requiring further inspection and handling; if the maliciousness score output by the model is less than the threshold, the flow is determined to be a normal flow, and no alert is triggered.

Through this series of operations, the embodiment of the present disclosure can accurately judge based on the maliciousness score of the flow to be detected from the graph convolutional neural network model, and promptly feed back the detection results through an alert mechanism. This ensures detection accuracy while avoiding unnecessary false alarms, ensuring the effective operation of network security protection.

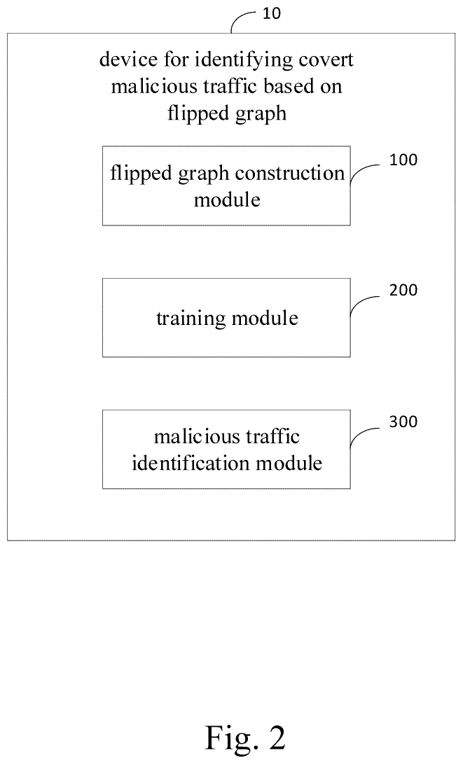

To implement the above embodiments, the present disclosure also provides a device for identifying covert malicious traffic based on a flipped graph. FIG. 2 is a schematic structural diagram of a device 10 for identifying covert malicious traffic based on a flipped graph in an embodiment of the present disclosure. As shown in FIG. 2, the device includes:
a flipped graph construction module 100, configured to construct a flipped graph of a traffic interaction by taking flows as nodes in the flipped graph and taking statistical features of the flows as node features, and determine edge connections between the nodes based on relationships between source addresses and destination addresses of the flows;
a training module 200, configured to perform a graph learning using a graph convolutional neural network, aggregate, for each node in the flipped graph, a node feature of each node and a feature of a neighboring node, and train a neural network model using a node label to identify a degree of maliciousness of each node;
a malicious traffic identification module 300, configured to input the node embedding of the flow to be detected into a trained graph convolutional neural network model to perform a malicious traffic identification.

Regarding the device in the above embodiment, the specific manner in which each module performs operations has been described in detail in the embodiments of the method, and will not be elaborated in detail here.

To implement the above embodiments, the present disclosure also provides an electronic device, including: a processor, and a memory communicatively connected to the processor; the memory stores computer-executable instructions; the processor executes the computer-executable instructions stored in the memory to implement the method provided in the preceding embodiments.

To implement the above embodiments, the present disclosure also provides a computer-readable storage medium, where the computer-readable storage medium stores computer-executable instructions, which when executed by a processor are used to implement the method provided in the preceding embodiments.

To implement the above embodiments, the present disclosure also provides a computer program product, including a computer program, which when executed by a processor implements the method provided in the preceding embodiments.

The collection, storage, use, processing, transmission, provision, and disclosure of user personal information involved in the present disclosure all comply with relevant laws and regulations and do not violate public order and good customs.

It should be noted that personal information from users should be collected for legitimate and reasonable purposes and not shared or sold outside these legitimate uses. Furthermore, such collection/sharing should be conducted after obtaining the user's informed consent, including but not limited to notifying the user to read the user agreement/user notification before using the function, and signing an agreement/authorization including authorization of relevant user information. Furthermore, any necessary steps should be taken to safeguard and secure access to such personal information data and ensure that others with access to the personal information data comply with their privacy policies and procedures.

The present disclosure is expected to provide users with implementations that selectively block the use of or access to personal information data. That is, the present disclosure is expected to provide hardware and/or software to prevent or block access to such personal information data. Once personal information data is no longer needed, risks can be minimized by restricting data collection and deleting data. Additionally, where applicable, such personal information is de-identified to protect user privacy.

In the description of the preceding embodiments, descriptions referring to terms “one embodiment,” “some embodiments,” “example,” “specific example,” or “some examples” etc. mean that specific features, structures, materials, or characteristics described in connection with the embodiment or example are included in at least one embodiment or example of the present disclosure. In this specification, the schematic representations of the above terms are not necessarily directed to the same embodiment or example. Furthermore, the described specific features, structures, materials, or characteristics may be combined in any suitable manner in any one or more embodiments or examples. In addition, without mutual contradiction, those skilled in the art can combine and assemble different embodiments or examples and features of different embodiments or examples described in this specification.

Furthermore, the terms “first” and “second” are used for descriptive purposes only and cannot be understood as indicating or implying relative importance or implicitly indicating the number of indicated technical features. Thus, features defined with “first” and “second” may explicitly or implicitly include at least one of the features. In the description of the present disclosure, “plurality” means at least two, such as two, three, etc., unless expressly and specifically defined otherwise.

Any process or method description in a flowchart or otherwise described herein can be understood as representing a module, segment, or portion of code including one or more executable instructions for implementing custom logic functions or steps of the process, and the scope of preferred implementations of the present disclosure includes additional implementations where functions may be performed not in the order shown or discussed, including substantially concurrently or in reverse order depending on the functions involved, which should be understood by those skilled in the art to which the embodiments of the present disclosure pertain.

The logic and/or steps represented in flowcharts or otherwise described herein, for example, can be considered as a sequenced list of executable instructions for implementing logical functions, and can be embodied in any computer-readable medium for use by or in connection with an instruction execution system, apparatus, or device (such as a computer-based system, a system including a processor, or other system that can fetch instructions from and execute instructions from an instruction execution system, apparatus, or device). For purposes of this specification, a “computer-readable medium” can be any means that can contain, store, communicate, propagate, or transport the program for use by or in connection with the instruction execution system, apparatus, or device. More specific examples (a non-exhaustive list) of computer-readable media include the following: an electrical connection with one or more wires (electronic device), a portable computer diskette (magnetic device), random access memory (RAM), read-only memory (ROM), erasable programmable read-only memory (EPROM or flash memory), fiber optic device, and portable compact disc read-only memory (CDROM). Additionally, the computer-readable medium could even be paper or other suitable medium on which the program is printed, as the program can be obtained electronically, for example, by optically scanning the paper or other medium, then compiling, interpreting, or otherwise processing in a suitable manner, and then stored in computer memory.

It should be understood that portions of the present disclosure may be implemented in hardware, software, firmware, or a combination thereof. In the above-described embodiments, multiple steps or methods may be implemented in software or firmware stored in memory and executed by a suitable instruction execution system. For example, if implemented in hardware, as in another embodiment, it may be implemented using any one or a combination of the following technologies known in the art: discrete logic circuits having logic gates for implementing logic functions on data signals, application-specific integrated circuits with suitable combinational logic gates, programmable gate arrays (PGA), field programmable gate arrays (FPGA), etc.

Those of ordinary skill in the art can understand that all or part of the steps carried by the methods of the above embodiments can be completed by instructing relevant hardware through a program, and the program can be stored in a computer-readable storage medium. When executed, the program includes one or a combination of the steps of the method embodiments.

Furthermore, each functional unit in each embodiment of the present disclosure may be integrated into one processing module, or each unit may exist physically separately, or two or more units may be integrated into one module. The above-integrated modules may be implemented in the form of hardware or in the form of software functional modules. If the integrated modules are implemented in the form of software functional modules and sold or used as independent products, they may also be stored in a computer-readable storage medium.

The aforementioned storage medium may be a read-only memory, a magnetic disk, or an optical disk, etc. Although the embodiments of the present disclosure have been shown and described above, it can be understood that the above embodiments are exemplary and should not be construed as limiting the present disclosure. Those of ordinary skill in the art may make changes, modifications, substitutions, and variations to the above embodiments within the scope of the present disclosure.

It should be understood that the various forms of processes shown above can be used to reorder, add, or delete steps. For example, the steps described in the present disclosure can be executed in parallel, sequentially, or in different orders, as long as the desired result of the technical solution of the present disclosure can be achieved, and no limitation is imposed herein.

The above specific implementation manners do not constitute a limitation on the protection scope of the present disclosure. It should be understood by those skilled in the art that various modifications, combinations, sub-combinations, and substitutions can be made according to design requirements and other factors. Any modification, equivalent replacement, and improvement made within the spirit and principle of the present disclosure shall be included within the scope of the present disclosure.

What is claimed is:

1. A method for identifying a covert malicious traffic based on a flipped graph, comprising:
constructing a flipped graph of a traffic interaction by taking flows as nodes in the flipped graph and taking statistical features of the flows as node features, and determining edge connections between the nodes based on relationships between source addresses and destination addresses of the flows;
performing a graph learning using a graph convolutional neural network, aggregating, for each node in the flipped graph, a node feature of each node and a feature of a neighboring node, and training a neural network model using a node label to identify a degree of maliciousness of each node;
constructing a node feature of a flow to be detected, finding a neighboring node in the flipped graph, and calculating a node embedding of the flow to be detected; and
inputting the node embedding of the flow to be detected into a trained graph convolutional neural network model to perform a malicious traffic identification.

2. The method according to claim 1, wherein constructing the flipped graph of the traffic interaction comprises:
processing a series of data packets with known labels arranged in time order into flows, calculating a statistical feature of each flow, and using dictionary flows to record flow information, wherein a key of the dictionary flows are flow identification information, and values of the dictionary flows are flow statistical features comprising a packet length distribution and a packet interval distribution;
converting the dictionary flows into an array flows_arr, combining keys and values of a dictionary as an array element content, and using a dictionary graph to record an association between an address and a flow index, wherein keys of the dictionary graph are the source addresses and the destination addresses, and a value of the dictionary graph is a corresponding flow index; and
obtaining a source address and a destination address of each element in the array flows_arr, and adding an index of the element respectively to dictionary entries keyed by the source address and the destination address, to construct a topological structure of the flipped graph of the traffic interaction.

3. The method according to claim 2, wherein performing the graph learning using the graph convolutional neural network, aggregating, for each node in the flipped graph, the node feature of each node and the feature of the neighboring node, and training the neural network model using the node label to identify the degree of maliciousness of each node comprises:
initializing the graph convolutional neural network model, wherein the graph convolutional neural network model comprises an embedding generator [symbol] and a discriminator [symbol] , the embedding generator [symbol] is used to calculate a current node embedding based on a feature of a current node and features of neighboring nodes, and the discriminator [symbol] is used to evaluate the degree of maliciousness of the current node based on the current node embedding and the feature of the current node;
training the graph convolutional neural network model, wherein v⁽ⁱ⁾ is defined as a feature of a node i and w⁽ⁱ⁾ is defined as an embedding of the node i,
$${𝒩}_{s}^{( i )}$$
is a set of neighboring nodes sharing a common source address with the node i,
$${𝒩}_{d}^{( i )}$$
is a set of neighboring nodes sharing a common destination address with the node i,
randomly sampling a fixed number of nodes from the set of neighboring nodes for an aggregation, adjusting aggregation weights based on similarities between the features of the neighboring nodes and the feature of the current node, respectively calculating embeddings of the neighboring nodes associated by the source address and by the destination address, and combining the embeddings of the neighboring nodes to serve as the embedding w⁽ⁱ⁾ of the current node i, wherein a merging formula is:
$${w}^{( i )} = ( \frac{{\sum }_{j ∈ Sample ( {𝒩}_{s}^{( i )} , k )} {r}_{j}^{( i )} \cdot {v}^{( j )}}{{\sum }_{j ∈ Sample ( {𝒩}_{s}^{( i )} , k )} {r}_{j}^{( i )}} \vert \vert \frac{{\sum }_{j ∈ Sample ( {𝒩}_{d}^{( i )} , k )} {r}_{j}^{( i )} \cdot {v}^{( j )}}{{\sum }_{j ∈ Sample ( {𝒩}_{d}^{( i )} , k )} {r}_{j}^{( i )}} )$$
wherein
$${r}_{j}^{( i )}$$
is a weight or neighboring node j, v^{(j)} is a feature of neighboring node j, Sample(S,k) represents randomly sampling k elements from set S, and ∥ represents concatenating two vectors end-to-end into one vector;
combining v⁽ⁱ⁾ and w⁽ⁱ⁾ and inputting the combined v⁽ⁱ⁾ and w⁽ⁱ⁾ into the discriminator [symbol] to obtain a score of maliciousness degree of node, and performing a backpropagation of a difference between the score of maliciousness degree of node output by the discriminator [symbol] and the node label to update parameters of the discriminator [symbol] ; and
performing a training process for each node in the flipped graph, and repeating the training process for multiple rounds until the discriminator [symbol] converges, outputting a maliciousness score of each node, and simultaneously recording a threshold for the trained data to achieve an optimal balance between recall rate and false positive rate, wherein a calculation method is:
$$threshold = arg max ( TPR \cdot ( 1 - FPR ) )$$
wherein TPR and FPR are respectively the recall rate and false positive rate of the model under different thresholds.

4. The method according to claim 3, wherein
the embedding generator [symbol] adopts a non-parametric algorithm and requires no initialization; and
the discriminator [symbol] adopts a neural network model, wherein in a case where a node feature dimension is d, an input dimension of the discriminator [symbol] is 3·d, and an output dimension of the discriminator [symbol] is 1; a neural network parameter of the discriminator [symbol] is initialized by a random initialization method as follows: for a parameter matrix A^{(l)} of layer l, wherein l>1, the elements of the parameter matrix A^{(l} follow a Gaussian distribution with a mean 0 and a variance \sqrt{2/nₗ₋₁}, where nₗ₋₁ is a number of neurons in a layer l−1, and parameters of a first layer are initialized as a random real matrix following a standard normal distribution.

5. The method according to claim 4, wherein constructing the node feature of the flow to be detected, finding the neighboring node in the flipped graph and calculating the node embedding of the flow to be detected, comprises:
obtaining a five-tuple array and flow statistical information of the flow to be detected, and adding the five-tuple array and the flow statistical information to the flow information array flows_arr;
based on a source address and a destination address of the flow to be detected, finding a source address neighbor set and a destination address neighbor set of the flow to be detected in an address-associated flow dictionary graph, and adding an index of the flow respectively to source address and destination address entries in the address-associated flow dictionary graph; and
merging an embedding of the source address neighbor node and an embedding of the destination address neighbor node to obtain the node embedding of the flow to be detected.

6. The method according to claim 5, wherein inputting the node embedding of the flow to be detected into the trained graph convolutional neural network model to perform the malicious traffic identification comprises:
inputting the calculated node embedding of the flow to be detected into the trained graph convolutional neural network model to obtain a maliciousness score of the flow; and
comparing the maliciousness score of the flow to be detected with the threshold to determine whether the flow to be detected is a malicious flow.

7. The method according to claim 6, wherein comparing the maliciousness score of the flow to be detected with the threshold to determine whether the flow to be detected is a malicious flow comprises:
in a case where the maliciousness score is greater than or equal to the threshold, determining that the flow is a malicious flow, and generating an alert message; and
in a case where the maliciousness score is less than the threshold, determining that the flow is a normal flow, and not triggering an alert.

8. An electronic device, comprising a processor, and a memory communicatively connected to the processor;
the memory stores computer-executable instructions; and
the processor executes the computer-executable instructions stored in the memory to perform:
constructing a flipped graph of a traffic interaction by taking flows as nodes in the flipped graph and taking statistical features of the flows as node features, and determining edge connections between the nodes based on relationships between source addresses and destination addresses of the flows;
performing a graph learning using a graph convolutional neural network, aggregating, for each node in the flipped graph, a node feature of each node and a feature of a neighboring node, and training a neural network model using a node label to identify a degree of maliciousness of each node;
constructing a node feature of a flow to be detected, finding a neighboring node in the flipped graph, and calculating a node embedding of the flow to be detected; and
inputting the node embedding of the flow to be detected into a trained graph convolutional neural network model to perform a malicious traffic identification.

9. The electronic device according to claim 8, wherein constructing the flipped graph of the traffic interaction comprises:
processing a series of data packets with known labels arranged in time order into flows, calculating a statistical feature of each flow, and using dictionary flows to record flow information, wherein a key of the dictionary flows are flow identification information, and values of the dictionary flows are flow statistical features comprising a packet length distribution and a packet interval distribution;
converting the dictionary flows into an array flows_arr, combining keys and values of a dictionary as an array element content, and using a dictionary graph to record an association between an address and a flow index, wherein keys of the dictionary graph are the source addresses and the destination addresses, and a value of the dictionary graph is a corresponding flow index; and
obtaining a source address and a destination address of each element in the array flows_arr, and adding an index of the element respectively to dictionary entries keyed by the source address and the destination address, to construct a topological structure of the flipped graph of the traffic interaction.

10. The electronic device according to claim 9, wherein performing the graph learning using the graph convolutional neural network, aggregating, for each node in the flipped graph, the node feature of each node and the feature of the neighboring node, and training the neural network model using the node label to identify the degree of maliciousness of each node comprises:
initializing the graph convolutional neural network model, wherein the graph convolutional neural network model comprises an embedding generator [symbol] and a discriminator [symbol] , the embedding generator [symbol] is used to calculate a current node embedding based on a feature of a current node and features of neighboring nodes, and the discriminator [symbol] 0 is used to evaluate the degree of maliciousness of the current node based on the current node embedding and the feature of the current node;
training the graph convolutional neural network model, wherein v⁽ⁱ⁾ is defined as a feature of a node i and w⁽ⁱ⁾ is defined as an embedding of the node i,
$${𝒩}_{s}^{( i )}$$
is a set of neighboring nodes sharing a common source address with the node i,
$${𝒩}_{d}^{( i )}$$
is a set of neighboring nodes sharing a common destination address with the node i,
randomly sampling a fixed number of nodes from the set of neighboring nodes for an aggregation, adjusting aggregation weights based on similarities between the features of the neighboring nodes and the feature of the current node, respectively calculating embeddings of the neighboring nodes associated by the source address and by the destination address, and combining the embeddings of the neighboring nodes to serve as the embedding w⁽ⁱ⁾ of the current node i, wherein a merging formula is:
$${w}^{( i )} = ( \frac{{\sum }_{j ∈ Sample ( {𝒩}_{s}^{( i )} , k )} {r}_{j}^{( i )} \cdot {v}^{( j )}}{{\sum }_{j ∈ Sample ( {𝒩}_{s}^{( i )} , k )} {r}_{j}^{( i )}} \vert \vert \frac{{\sum }_{j ∈ Sample ( {𝒩}_{d}^{( i )} , k )} {r}_{j}^{( i )} \cdot {v}^{( j )}}{{\sum }_{j ∈ Sample ( {𝒩}_{d}^{( i )} , k )} {r}_{j}^{( i )}} )$$
wherein
$${r}_{j}^{( i )}$$
is a weight of neighboring node j, v^{(j)} is a feature of neighboring node j, Sample(S,k) represents randomly sampling k elements from set S, and ∥ represents concatenating two vectors end-to-end into one vector;
combining v⁽ⁱ⁾ and w⁽ⁱ⁾ and inputting the combined v⁽ⁱ⁾ and w⁽ⁱ⁾ into the discriminator [symbol] to obtain a score of maliciousness degree of node, and performing a backpropagation of a difference between the score of maliciousness degree of node output by the discriminator [symbol] and the node label to update parameters of the discriminator [symbol] ; and
performing a training process for each node in the flipped graph, and repeating the training process for multiple rounds until the discriminator [symbol] converges, outputting a maliciousness score of each node, and simultaneously recording a threshold for the trained data to achieve an optimal balance between recall rate and false positive rate, wherein a calculation method is:
$$threshold = arg max ( TPR \cdot ( 1 - FPR ) )$$
wherein TPR and FPR are respectively the recall rate and false positive rate of the model under different thresholds.

11. The electronic device according to claim 10, wherein
the embedding generator [symbol] adopts a non-parametric algorithm and requires no initialization; and
the discriminator [symbol] adopts a neural network model, wherein in a case where a node feature dimension is d, an input dimension of the discriminator [symbol] is 3·d, and an output dimension of the discriminator [symbol] is 1; a neural network parameter of the discriminator [symbol] is initialized by a random initialization method as follows: for a parameter matrix A^{(l)} of layer l, wherein l>1, the elements of the parameter matrix A^{(l)} follow a Gaussian distribution with a mean 0 and a variance \sqrt{2/nₗ₋₁}, where nₗ₋₁ is a number of neurons in a layer l−1, and parameters of a first layer are initialized as a random real matrix following a standard normal distribution.

12. The electronic device according to claim 11, wherein constructing the node feature of the flow to be detected, finding the neighboring node in the flipped graph and calculating the node embedding of the flow to be detected, comprises:
obtaining a five-tuple array and flow statistical information of the flow to be detected, and adding the five-tuple array and the flow statistical information to the flow information array flows_arr;
based on a source address and a destination address of the flow to be detected, finding a source address neighbor set and a destination address neighbor set of the flow to be detected in an address-associated flow dictionary graph, and adding an index of the flow respectively to source address and destination address entries in the address-associated flow dictionary graph; and
merging an embedding of the source address neighbor node and an embedding of the destination address neighbor node to obtain the node embedding of the flow to be detected.

13. The electronic device according to claim 12, wherein inputting the node embedding of the flow to be detected into the trained graph convolutional neural network model to perform the malicious traffic identification comprises:
inputting the calculated node embedding of the flow to be detected into the trained graph convolutional neural network model to obtain a maliciousness score of the flow; and
comparing the maliciousness score of the flow to be detected with the threshold to determine whether the flow to be detected is a malicious flow.

14. The electronic device according to claim 13, wherein comparing the maliciousness score of the flow to be detected with the threshold to determine whether the flow to be detected is a malicious flow comprises:
in a case where the maliciousness score is greater than or equal to the threshold, determining that the flow is a malicious flow, and generating an alert message; and
in a case where the maliciousness score is less than the threshold, determining that the flow is a normal flow, and not triggering an alert.

15. A computer-readable storage medium, having stored therein computer-executable instructions that, when executed by a processor, cause the following method to be implemented:
constructing a flipped graph of a traffic interaction by taking flows as nodes in the flipped graph and taking statistical features of the flows as node features, and determining edge connections between the nodes based on relationships between source addresses and destination addresses of the flows;
performing a graph learning using a graph convolutional neural network, aggregating, for each node in the flipped graph, a node feature of each node and a feature of a neighboring node, and training a neural network model using a node label to identify a degree of maliciousness of each node;
constructing a node feature of a flow to be detected, finding a neighboring node in the flipped graph, and calculating a node embedding of the flow to be detected; and
inputting the node embedding of the flow to be detected into a trained graph convolutional neural network model to perform a malicious traffic identification.

16. The computer-readable storage medium according to claim 15, wherein constructing the flipped graph of the traffic interaction comprises:
processing a series of data packets with known labels arranged in time order into flows, calculating a statistical feature of each flow, and using dictionary flows to record flow information, wherein a key of the dictionary flows are flow identification information, and values of the dictionary flows are flow statistical features comprising a packet length distribution and a packet interval distribution;
converting the dictionary flows into an array flows_arr, combining keys and values of a dictionary as an array element content, and using a dictionary graph to record an association between an address and a flow index, wherein keys of the dictionary graph are the source addresses and the destination addresses, and a value of the dictionary graph is a corresponding flow index; and
obtaining a source address and a destination address of each element in the array flows_arr, and adding an index of the element respectively to dictionary entries keyed by the source address and the destination address, to construct a topological structure of the flipped graph of the traffic interaction.

17. The computer-readable storage medium according to claim 16, wherein performing the graph learning using the graph convolutional neural network, aggregating, for each node in the flipped graph, the node feature of each node and the feature of the neighboring node, and training the neural network model using the node label to identify the degree of maliciousness of each node comprises:
initializing the graph convolutional neural network model, wherein the graph convolutional neural network model comprises an embedding generator [symbol] and a discriminator [symbol] , the embedding generator [symbol] is used to calculate a current node embedding based on a feature of a current node and features of neighboring nodes, and the discriminator [symbol] is used to evaluate the degree of maliciousness of the current node based on the current node embedding and the feature of the current node;
training the graph convolutional neural network model, wherein v⁽ⁱ⁾ is defined as a feature of a node i and w⁽ⁱ⁾ is defined as an embedding of the node i,
$${𝒩}_{s}^{( i )}$$
is a set or neighboring nodes sharing a common source address with the node i,
$${𝒩}_{d}^{( i )}$$
is a set of neighboring nodes sharing a common destination address with the node i,
randomly sampling a fixed number of nodes from the set of neighboring nodes for an aggregation, adjusting aggregation weights based on similarities between the features of the neighboring nodes and the feature of the current node, respectively calculating embeddings of the neighboring nodes associated by the source address and by the destination address, and combining the embeddings of the neighboring nodes to serve as the embedding w⁽ⁱ⁾ of the current node i, wherein a merging formula is:
$${w}^{( i )} = ( \frac{{\sum }_{j ∈ Sample ( {𝒩}_{s}^{( i )} , k )} {r}_{j}^{( i )} \cdot {v}^{( j )}}{{\sum }_{j ∈ Sample ( {𝒩}_{s}^{( i )} , k )} {r}_{j}^{( i )}} \vert \vert \frac{{\sum }_{j ∈ Sample ( {𝒩}_{d}^{( i )} , k )} {r}_{j}^{( i )} \cdot {v}^{( j )}}{{\sum }_{j ∈ Sample ( {𝒩}_{d}^{( i )} , k )} {r}_{j}^{( i )}} )$$
wherein
$${r}_{j}^{( i )}$$
is a weight or neighboring node j, v^{(j)} is a feature of neighboring node j, Sample(S,k) represents randomly sampling k elements from set S, and ∥ represents concatenating two vectors end-to-end into one vector;
combining v⁽ⁱ⁾ and w⁽ⁱ⁾ and inputting the combined v⁽ⁱ⁾ and w⁽ⁱ⁾ into the discriminator [symbol] to obtain a score of maliciousness degree of node, and performing a backpropagation of a difference between the score of maliciousness degree of node output by the discriminator [symbol] and the node label to update parameters of the discriminator [symbol] ; and
performing a training process for each node in the flipped graph, and repeating the training process for multiple rounds until the discriminator [symbol] converges, outputting a maliciousness score of each node, and simultaneously recording a threshold for the trained data to achieve an optimal balance between recall rate and false positive rate, wherein a calculation method is:
$$threshold = arg max ( TPR \cdot ( 1 - FPR ) )$$
wherein TPR and FPR are respectively the recall rate and false positive rate of the model under different thresholds.

18. The computer-readable storage medium according to claim 17, wherein
the embedding generator [symbol] adopts a non-parametric algorithm and requires no initialization; and
the discriminator [symbol] adopts a neural network model, wherein in a case where a node feature dimension is d, an input dimension of the discriminator [symbol] is 3·d, and an output dimension of the discriminator [symbol] is 1; a neural network parameter of the discriminator [symbol] is initialized by a random initialization method as follows: for a parameter matrix A^{(l)} of layer l, wherein l>1, the elements of the parameter matrix A^{(l)} follow a Gaussian distribution with a mean 0 and a variance \sqrt{2/nₗ₋₁}, where nₗ₋₁ is a number of neurons in a layer l−1, and parameters of a first layer are initialized as a random real matrix following a standard normal distribution.

19. The computer-readable storage medium according to claim 18, wherein constructing the node feature of the flow to be detected, finding the neighboring node in the flipped graph and calculating the node embedding of the flow to be detected, comprises:
obtaining a five-tuple array and flow statistical information of the flow to be detected, and adding the five-tuple array and the flow statistical information to the flow information array flows_arr;
based on a source address and a destination address of the flow to be detected, finding a source address neighbor set and a destination address neighbor set of the flow to be detected in an address-associated flow dictionary graph, and adding an index of the flow respectively to source address and destination address entries in the address-associated flow dictionary graph; and
merging an embedding of the source address neighbor node and an embedding of the destination address neighbor node to obtain the node embedding of the flow to be detected.

20. The computer-readable storage medium according to claim 19, wherein inputting the node embedding of the flow to be detected into the trained graph convolutional neural network model to perform the malicious traffic identification comprises:
inputting the calculated node embedding of the flow to be detected into the trained graph convolutional neural network model to obtain a maliciousness score of the flow; and
comparing the maliciousness score of the flow to be detected with the threshold to determine whether the flow to be detected is a malicious flow.
